(19) United States
(12) Patent Application Publication
(10) Pub. No.: US 2004/0097225 A1
(43) Pub. Date: May 20, 2004

(54) Method and device for debiting wireless data transmissions

(76) Inventors: Kjell Westerberg, Floda (SE); Peter Kaltenbrunner, Goteborg (SE)

Correspondence Address: NIXON & VANDERHYE, PC, 1100 N GLEBE ROAD, 8TH FLOOR, ARLINGTON, VA, 22201-4714, US

(21) Appl. No.: 10/473,428

(22) PCT Filed: Mar. 27, 2002
(86) PCT No.: PCT/EP02/03679

(30) Foreign Application Priority Data
Mar. 30, 2001 (US) 60279717

(51) Int. Cl. H04L 12/66; H04Q 7/20; H04B 1/38; H04M 1/00

(52) U.S. Cl. 455/426.1; 370/352; 455/560; 455/445

(57) ABSTRACT

The invention relates to a wireless radio network for packaged wireless data transmissions, in particular to a method and device, respectively, for debiting packaged wireless data transmissions between a mobile terminal (1) and a base station (2). The invention is characterized in that the debiting concerning said MT (1) is based on the total quantity of all data that is transferred between the MT (1) and the base station (2), irrespective of the quality of the transfer. Thus the invention provides an incentive for a mobile terminal (MT) user for trying to enhance the radio signal coverage, resulting in a more efficient use of wireless radio links.

### TECHNICAL FIELD

The invention relates to packaged wireless data transmissions, in particular to a method and device, respectively, for debiting packaged wireless data transmissions between a mobile terminal and a base station, peferably in a wireless radio network.

### BACKGROUND ART

Today, mobile terminals (MT) are used for transferring, i.e. sending and receiving packaged data to and from a base station, for example e-mails. Different systems are used for this service, by way of example the Mobitex system. Common for these systems is that the operator only debits either a fixed amount per time period or the correctly received data amount, by counting the bytes that are correctly transferred on a radio link and using this information as debiting information. When an MT is within an area with a bad coverage or a bad radio environment the data might not be transferred properly, resulting in the data being re-sent. This process continues until the data transfer is properly accomplished. But then the radio link is poorly used, as the same data amount is re-sent one or more times, occupying the radio link. This problem with poor use of the radio link has until now been remedied by the operator that has to build new base stations, which is an unsatisfactory solution that the operator has to pay for. But today there is no incentive for the MT user for trying to enhance the radio signal coverage, by way of example by moving to another area or using a larger antenna. Thus the user does not try to improve the transfer quality, making poor use of the radio link.

### DISCLOSURE OF INVENTION

It is an object of the present invention to provide a more efficient use of wireless radio links for packaged data, by providing a method and device, respectively, for creating an incentive for a mobile terminal (MT) user for trying to enhance the radio signal coverage.

The object is solved by basing the debiting concerning said MT on the total quantity of all data that is transferred between the MT and the base station, irrespective of the quality of the transfer.

Preferable embodiments of the invention are disclosed in the appended dependent claims.

### BRIEF DESCRIPTION OF DRAWINGS

The invention will be described below in connection with an example of a preferred embodiment and the enclosed drawings, where

FIG. 1 is a schematic view of a mobile terminal contacting a base station;

FIG. 2 shows a simplified drawing of a cellular grid, typical for mobile communication systems such as the Mobitex system;

FIG. 3 is a schematic view of a mobile terminal contacting a base station, where the coverage is disturbed by a natural obstruction;

FIG. 4 is a simplified block diagram showing an example of the present invention;

FIG. 5 is a schematic view of mobile terminal antenna placements for a vehicle; and

FIG. 6 is a schematic view of mobile terminal antenna placements for a building.

### MODE FOR CARRYING OUT THE INVENTION

This invention constitutes an improvement in the field of wireless data networks, in particular wireless package data networks. Due to the development of equipment for wireless transfer of data, for example e-mail, many network operators are establishing such services for their customers.

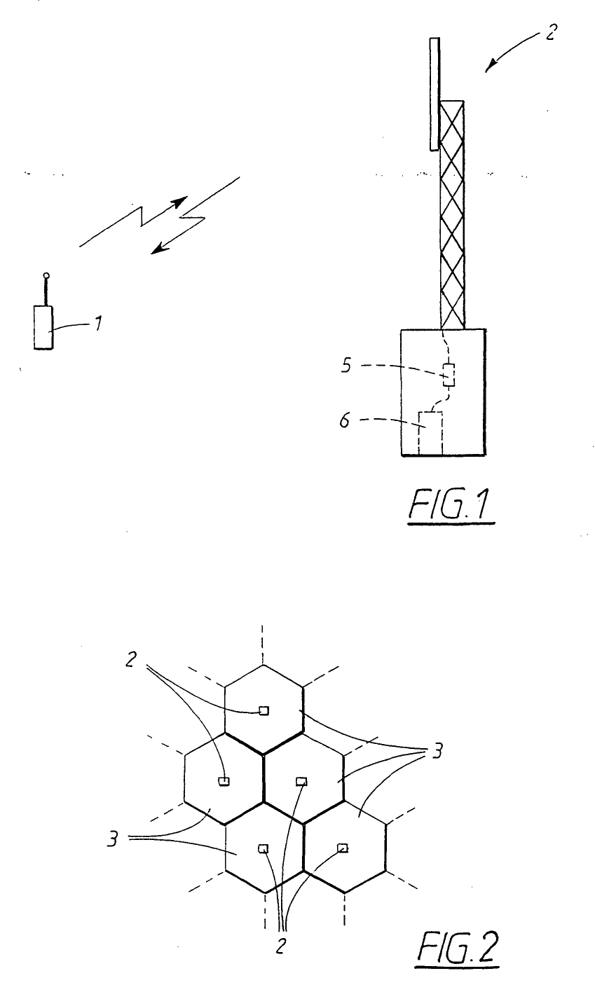

As shown in FIG. 1, mobile terminals 1 (MT) are used for transferring, i.e. sending and receiving, packaged data to and from a base station 2, for example e-mails. Different systems are used for this service, by way of example the Mobitex system. As shown in FIG. 2, the Mobitex network consists of interconnected cells 3, each of which is served by a base station 2 that provides wireless access to the network for mobile users. The base stations 2 and other network nodes are connected together by fixed radio links. Using the Mobitex system, the complete transmission, by way of example an e-mail, comprises a data package. This data package is then divided into smaller parts, called blocks. Each Mobitex block contains 18 bytes, and thus, for example, an e-mail of 180 bytes results in 10 blocks.

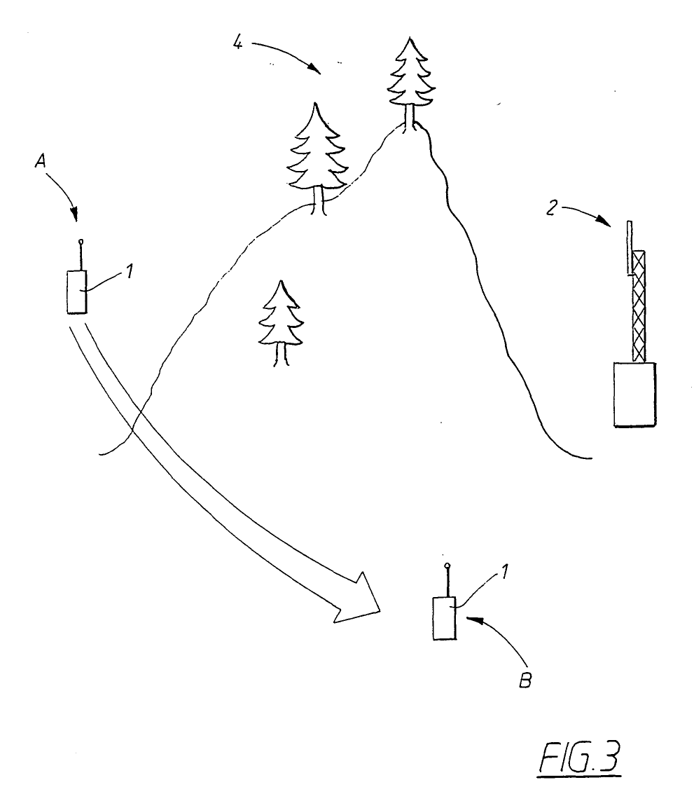

With reference to FIG. 3, an MT 1 may be within an area with a bad radio coverage, which bad radio coverage may be caused by a natural obstruction, by way of example a mountain 4, at the position A. The user may also be in a bad radio environment with a lot of disturbances. This results in that the data might not be transferred properly, resulting in the data being re-sent. This process continues until the data transfer is properly accomplished. But then the radio link is poorly used, as the same data amount is re-sent one or more times, occupying the radio link. According to what is previously known, the operator only debits either a fixed amount per time period, or the correctly received data amount, by counting the bytes that are correctly transferred on a radio link and using this information as debiting information. This problem with poor use of the radio link has until now forced the operator to build new base stations 2, which the operator has to pay for. The indication of the quality of the transfer, i.e. whether a transferred amount of data is correctly received or not, is carried out by means of the protocol. For, by way of example, the Mobitex system, an ACK (Acknowledge) package is sent when the transfer of a data package is completed. If the transmitter does not receive an ACK package, the data package must be re-sent. Since the data packages in the Mobitex system are divided into smaller parts, the blocks, only those blocks that have not been correctly received will be re-sent. The invention is, however, not limited to the Mobitex system, and the amount of data that is transferred may be divided into other smaller parts than said blocks. On the other hand, said amount of data does not have to be divided into smaller parts at all.

According to the invention, by debiting the user of the MT 1 for the total amount of data that is transferred between the MT 1 and the base station 2, irrespective of if it is received correctly, the user has an incentive to improve the transmission conditions. The invention is applicable for both uplink transmissions (from the MT 1 to the base station 2) and for downlink transmissions (from the base station 2 to the MT 1).

Shown in FIG. 1, in a preferred embodiment, the invention may be implemented by means of installing a suitable software in a processing device 5 close to the radio 6 in the base station 2, which processing device 5 also handles the link protocol.

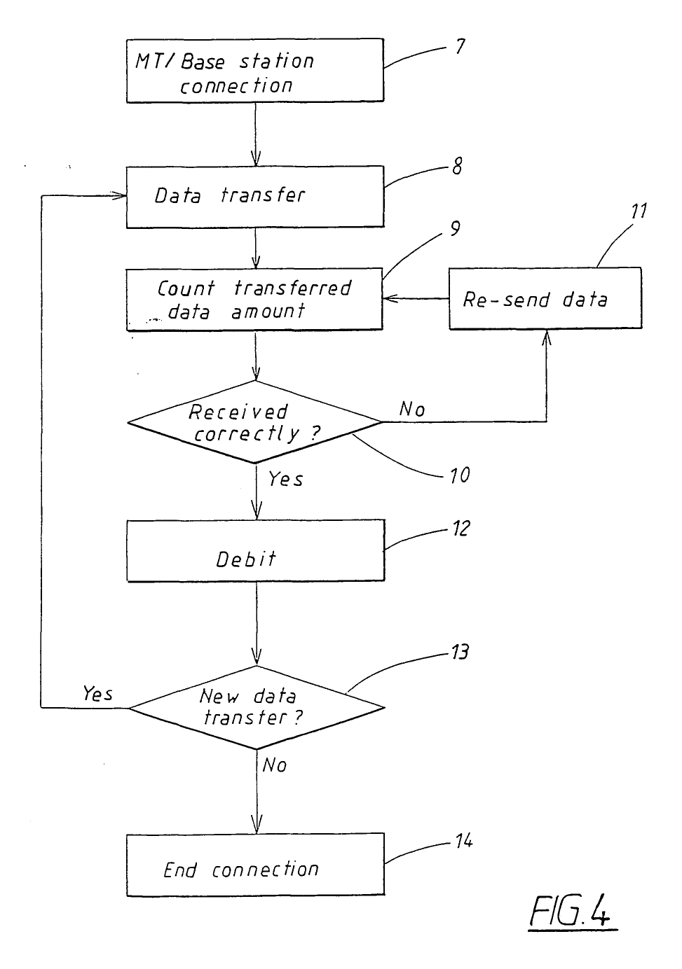

FIG. 4 discloses a simplified block diagram showing an example of the present invention. The blocks are described below:

7: First, a connection is established between an MT and a base station.

8: Then data transfer takes place.

9: Count the amount of data that has been transferred.

10: Are the transferred data received correctly?

11: If no, re-send the data, return to block 9.

12: If yes at block 9, if the transferred data are received correctly, then debit the total amount of data that has been transferred.

13: Will there be another data transfer? If yes, return block 8.

14: If no, then end the connection between the MT and the base station.

Also, in a preferred embodiment, the MT user is debited for each data block that is transferred, using the Mobitex system, making a block the smallest information unit that it is possible to debit.

A number of situations where the user of an MT 1 has an opportunity to improve the transmission conditions between the MT 1 and the base station 2 will now be described with reference to FIGS. 3, 5 and 6.

As shown in FIG. 3, an MT 1 that is in the radio shadow of a natural obstruction, by way of example a mountain 4, at the position A, may be moved to position B in order to improve the signal quality. An indication of the signal strength is provided by an indicator on the display of the MT 1.

As shown in FIG. 5, the owner of a vehicle 15 may provide the vehicle with a large antenna 16 at an advantageous location B instead of a small antenna 17 at a disadvantageous location A, that in the figure is inside the compartment of the vehicle 15. This embodiment example may concern vehicles that are automatically tracked, by way of example cold-storage vehicles which may be tracked quickly if the cooling unit malfunctions.

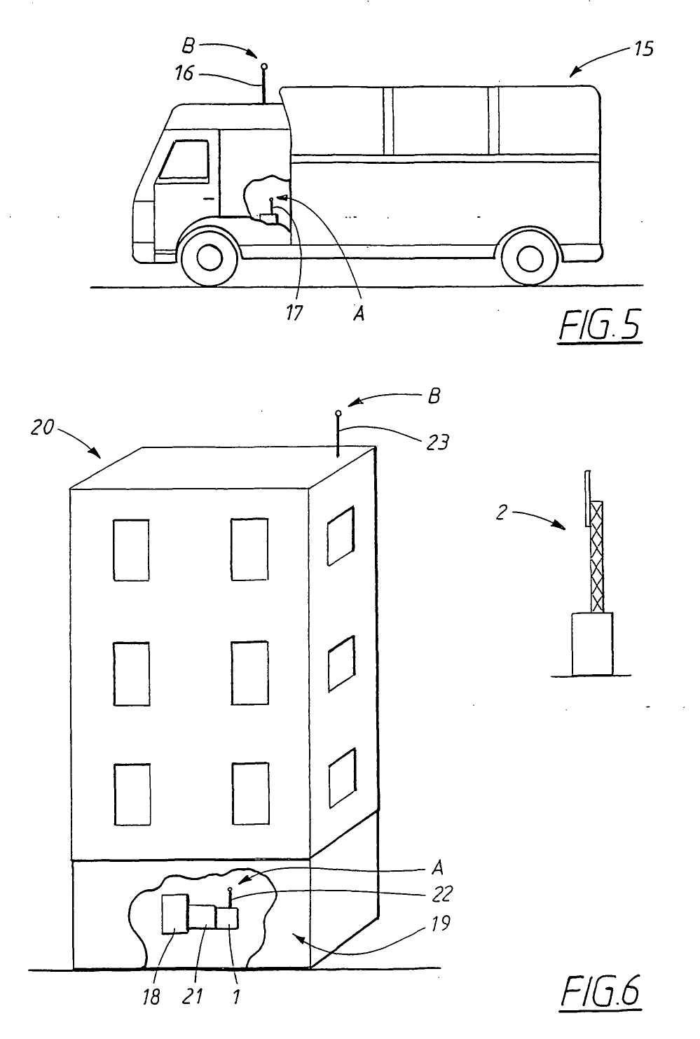

As shown in FIG. 6, an MT 1 is used for remote surveillance of an electricity meter 18 placed in the cellar 19 of a building 20, which surveillance is conducted by means of a data interface system 21. Here, with the base station 2 positioned according to FIG. 6, the location A of an antenna 22 inside the cellar 19 provides a poor transmission quality compared with the location B of an antenna 23 on the roof of the building 20. With the position of the base station 2 known for the user of the MT 1 in question, a proper placement of such an antenna 23 is easy to perform, also using the signal strength indicator of the MT 1.

It is to be noted that the embodiment example described above only is an example of how the invention may be applied. The radio system is not limited to Mobitex, but the invention may be applied to any suitable radio system, by way of example GPRS (Global Packet Radio Service).

The invention is not limited to what has been described above, but may be varied freely within the scope of the appended claims.

1. A method for debiting packaged wireless data transmissions between a mobile terminal (1) (MT) and a base station (2), characterized in that the debiting concerning said MT (1) is based on the total quantity of all data that is transferred between the MT (1) and the base station (2), irrespective of the quality of the transfer.

2. Method according to claim 1, characterized in that said quality of the transfer is determined by detection of whether a transferred amount of data is correctly received or not.

3. Method according to any one of the claims 1 or 2, characterized in that said method is used in the Mobitex system.

4. Method according to claim 3, characterized in that said quality of the transfer is indicated by means of whether an ACK package is sent to the transmitter or not.

5. Method according to any one of the claims 1 or 2, characterized in that said method is used for GPRS (Global Packet Radio Service).

6. Method according to claim 3 where said transferred data is divided into blocks, characterized in that the debiting concerning said MT (1) is based on the number of blocks that are transferred between the MT (1) and the base station (2), irrespective of the quality of the transfer.

7. Device (5) for debiting packaged wireless data transmissions between a mobile terminal (1) (MT) and a base station (2) characterized in that said device (5) is adapted for basing the debiting concerning said MT (1) on the total quantity of all data that is transferred between the MT (1) and the base station (2), irrespective of the quality of the transfer.

8. Device (5) according to claim 7, characterized in that said device (5) is adapted for determining said quality of the transfer by detecting whether a transferred amount of data is correctly received or not.

9. Device (5) according to any one of the claims 7 or 8, characterized in that said device (5) is adapted for being used in the Mobitex system.

10. Device (5) according to claim 9, characterized in that said device (5) is adapted for indicating the quality of the transfer by means of deciding whether an ACK package shall be sent to the transmitter or not.

11. Device (5) according to any one of the claims 7 or 8, characterized in that said device (5) is adapted for being used for GPRS (Global Packet Radio Service).

12. Device (5) according to claim 9 where said transferred data is divided into blocks, characterized in that said device (5) is adapted for basing the debiting concerning said MT (1) on the number of blocks that are transferred between the MT (1) and the base station (2), irrespective of the quality of the transfer.
